(19) United States
(12) Patent Application Publication
(10) Pub. No.: US 2011/0054950 A1
(43) Pub. Date: Mar. 3, 2011

(54) METHOD AND SYSTEM FOR PROVIDING A COMBINATION INCLUDING AN INSURANCE POLICY AND A SAVINGS PLAN

(75) Inventor: Amnon PELZ, Oranit (IL)

(73) Assignee: TABURIT - THE CENTRAL CORD BLOOD REGISTRY LTD., Ramat Hasharon (IL)

(21) Appl. No.: 12/869,470

(22) Filed: Aug. 26, 2010

Related U.S. Application Data
(60) Provisional application No. 61/237,359, filed on Aug. 27, 2009.

(51) Int. Cl. G06Q 40/00

(52) U.S. Cl. 705/4

(57) ABSTRACT

The invention provides a combination of an insurance policy and a savings plan in which a periodic deposit is made. The insurance policy stipulates that a depositor is indemnified for expenses incurred for a medical or cosmetic treatment requiring body material of the type deposited by a depositor in depository. The savings plan specifies that an accrued value of the savings plan may be utilized to defer costs of maintaining the body tissue or body organ in the depository if the depositor ceases to pay a predetermined periodic service payment to the depository. The invention also provides a system for a method for providing the combination of the invention, and a system for carrying out the method of the invention.

### FIELD OF THE INVENTION

This invention relates to methods and systems for providing insurance.

### BACKGROUND OF THE INVENTION

Bone marrow transplantation is used in the treatment of various disorders such as cancer, autoimmune diseases, blood disorders and metabolic disorders. These treatments take advantage of stem cells present in the bone marrow. However, a compatible bone marrow donor can only be found for 40-50% of all cases requiring bone marrow transplantation, and finding a suitable donor can take many weeks, and even months. Umbilical cord-blood also contains stem cells, and has been used as an alternative to bone marrow as a source of stem cells in the treatment of these disorders.

Umbilical blood is newborn blood collected from the umbilical cord after severing of the cord from the newborn. Banks of umbilical cord-blood have been set up in several countries. An individual's cord-blood is collected at birth, and in exchange for a periodic payment, the cord-blood is cryo-preserved for long term storage and deposited in a cord-blood depository or bank. The deposited cord-blood is used if the individual should subsequently develop a condition that can be treated by implantation of stem cells derived from his cord-blood. A person whose cord-blood was deposited in a bank at birth can thus be assured of a compatible source of stem cells, and is not dependent upon finding a suitable donor. Furthermore, due to the immaturity of cord-blood derived stem cells, a perfect tissue-typing (HLA) is often not required, in which case cord-blood may be used to treat a sibling of the cord donor. It should also be noted that cord-blood stem cells may be cultured ex-vivo in order to increase the number of stem cells available to the recipient.

U.S. patent application Ser. No. 10/134,055 to Richard, having the publication number US 2003/0014285, discloses a business method in which an insurance company pays the costs of depositing cord-blood in a cord-blood bank for a policy holder of the insurance company. The insurance company may offer this benefit, for example, in order to attract new policy holders. The cost of the deposition may be recouped from the premium of the insurance policy.

US Patent Publication 2006/019030 discloses a method for providing insurance to an individual who has deposited a body tissue or organ in a depository of such organs or tissues. An insurance policy is established for an individual who has deposited a body tissue or organ in the depository or for a beneficiary of the depositor. The insurance policy, in exchange for payment of a periodic premium, indemnifies the policy holder or his beneficiary for at least some of the expenses associated with a medical or cosmetic treatment that requires body material of the type previously deposited by the depositor in the depository.

After an individual has deposited a body tissue or organ in a depository, the individual is required to pay a periodic payment to cover the cost of maintaining the deposited material in the depository. Government regulations, or other considerations, may specify that any body material deposited in a depository cannot, under any circumstances, be destroyed, even if the depositor ceases to pay the periodic payment. Under these circumstances, the depository often has to absorb the cost of maintaining the deposited material.

### SUMMARY OF THE INVENTION

In its first aspect, the present invention provides a combination insurance policy and savings plan for an individual who has deposited a body tissue sample or organ sample in a depository of such organs or tissues. The combination of the invention includes an insurance policy that is established for an individual who has deposited a body tissue sample or organ sample in the depository or for a beneficiary of the depositor. The insurance policy, in exchange for payment of a periodic premium, indemnifies the policy holder or his beneficiary for at least some of the expenses associated with a medical or cosmetic treatment that requires body material of the type previously deposited by the depositor in the depository.

As used herein, the term “depositor” refers to an individual who has deposited a body tissue or organ in a depository of such tissues or organs, or a guardian or other party authorized to act on behalf of the individual.

The combination of the invention further includes a savings plan in which a periodic payment is made. The savings plan may terminate at a predetermined time, for example after a predetermined number of years, or when the beneficiary of the insurance policy reaches a predetermined age, at which time the accrued value of the savings plan is paid to the beneficiary.

In accordance with the invention, at any time during the life time of the savings plan, any or all of the accrued value of the savings plan may be used to cover the cost of maintaining the individual's deposit in the depository in the event that the individual ceases to pay the periodic payments to the depository.

The deposited body tissue or organ may be, for example, umbilical cord-blood or blood from another source, foreskin or other skin, lymph, fetal stem cells, adult stem cells, lymph, sperm or DNA.

In its second aspect, the invention provides a system for providing insurance. The system of the invention comprises a processor having a database of entries. The processor is configured to input data indicative of an insurance policy provided by an insurance provider to a depositor of body material in a depository of body material, and to store the data in the database, where the insurance policy stipulates that the depositor or a beneficiary of the depositor is indemnified for expenses incurred for a medical or cosmetic treatment utilizing the deposited body material or substitute body material of the type deposited by the depositor. The processor is also configured to input data indicative of a savings plan in which a periodic deposit is made, the savings plan specifying that an accrued value of the savings plan may be utilized to defer costs of maintaining the body tissue or body organ in the depository if the individual ceases to pay a predetermined periodic service payment to the depository. The processor is also configured to input data indicative of service payments made by the individual, and to issue an alert when a service payment was not paid when the service payment was due.

Thus, in its first aspect, the present invention provides a combination comprising:
(a) an insurance policy stipulating that a depositor or a beneficiary of a depositor is indemnified for expenses incurred for a medical or cosmetic treatment requiring body material of the type deposited by the depositor, wherein the medical treatment utilizes either the deposited body material or substitute body material of the type deposited by the depositor; and
(b) a savings plan in which a periodic deposit is made and specifying that an accrued value of the savings plan may be utilized to defer costs of maintaining the body tissue or body organ in the depository if the individual ceases to pay a predetermined periodic service payment to the depository.

In its second aspect, the invention provides a method for providing insurance comprising:
(a) establishing an insurance policy stipulating that a depositor or a beneficiary of a depositor is indemnified for expenses incurred for a medical or cosmetic treatment requiring body material of the type deposited by the depositor, wherein the medical treatment utilizes either the deposited body material or substitute body material of the type deposited by the depositor; and
(b) establishing a savings plan in which a periodic deposit is made and specifying that an accrued value of the savings plan may be utilized to defer costs of maintaining the body tissue or body organ in the depository if the individual ceases to pay a predetermined periodic service payment to the depository.

The method of the invention may further comprise indemnifying the depositor or beneficiary of the depositor for expenses incurred for a medical treatment utilizing the deposited body material. In the method of the invention, the deposited body material may be, for example, blood, umbilical cord blood, skin, foreskin, lymph, adult stem cells, fetal stem cells sperm, or DNA.

The method of the invention may further comprise storing in a database data indicative of the insurance policy. The method of the invention may further comprise storing in a database data indicative of the savings plan.

The stored data may be any one or more of a name of a holder of the insurance policy, the date that the deposit was made, information relating to the deposited body material, a serial number or other identifier associated with the deposit, a location of the deposited body material in the depository, a periodic sum to be deposited in the savings plan. In particular, the stored data may include a periodic sum to be deposited in the savings plan.

In another of its aspects, the invention provides a system for providing combination, the combination comprising:
(a) an insurance policy stipulating that a depositor or a beneficiary of a depositor is indemnified for expenses incurred for a medical or cosmetic treatment requiring body material of the type deposited by the depositor, wherein the medical treatment utilizes either the deposited body material or substitute body material of the type deposited by the depositor; and
(b) a savings plan in which a periodic deposit is made and specifying that an accrued value of the savings plan may be utilized to defer costs of maintaining the body tissue or body organ in the depository if the individual ceases to pay a predetermined periodic service payment to the depository;
the system comprising a processor and a database of entries, the processor configured to:
   (a) input data indicative of an insurance policy provided by an insurance provider to a depositor of body material in a depository of body material, and to store the data in an entry of the database, the insurance policy stipulating that the depositor or a beneficiary of the depositor is indemnified for expenses incurred for a medical or cosmetic treatment utilizing the deposited body material or substitute body material of the type deposited by the depositor; and
   (b) input data indicative of a savings plan in which a periodic deposit is made, the savings plan specifying that an accrued value of the savings plan may be utilized to defer costs of maintaining the body tissue or body organ in the depository if the individual ceases to pay a predetermined periodic service payment to the depository;
   (c) input data indicative of service payments made by the individual;
   (d) issue an alert when a service payment was not paid when the service payment was due.

The processor may be configured to indemnifying the depositor or beneficiary of the depositor for expenses incurred for a medical treatment utilizing the deposited body material.

In the system of the invention, the deposited body material may be selected from blood, umbilical cord blood, skin, foreskin, lymph, adult stem cells, fetal stem cells sperm, and DNA.

The processor of the invention may be configured to store in a database data indicative of the insurance policy. The processor may be configured to store in a database data indicative of the savings plan.

The stored data may be any one or more of a name of a holder of the insurance policy, the date that the deposit was made, information relating to the deposited body material, a serial number or other identifier associated with the deposit, a location of the deposited body material in the depository, a periodic sum to be deposited in the savings plan. In particular, the stored data may a periodic sum to be deposited in the savings plan.

### BRIEF DESCRIPTION OF THE DRAWINGS

In order to understand the invention and to see how it may be carried out in practice a preferred embodiment will now be described by way of non-limiting example only, with reference to the accompanying drawings, in which:

FIG. 1 shows a flow chart for a method of providing a combination combination of an insurance policy and a saving plan in accordance with one embodiment of this aspect of the invention; and

FIG. 2 shows a system for providing a combination of an insurance policy and a saving plan in accordance with this aspect of the invention.

### DESCRIPTION OF THE INVENTION

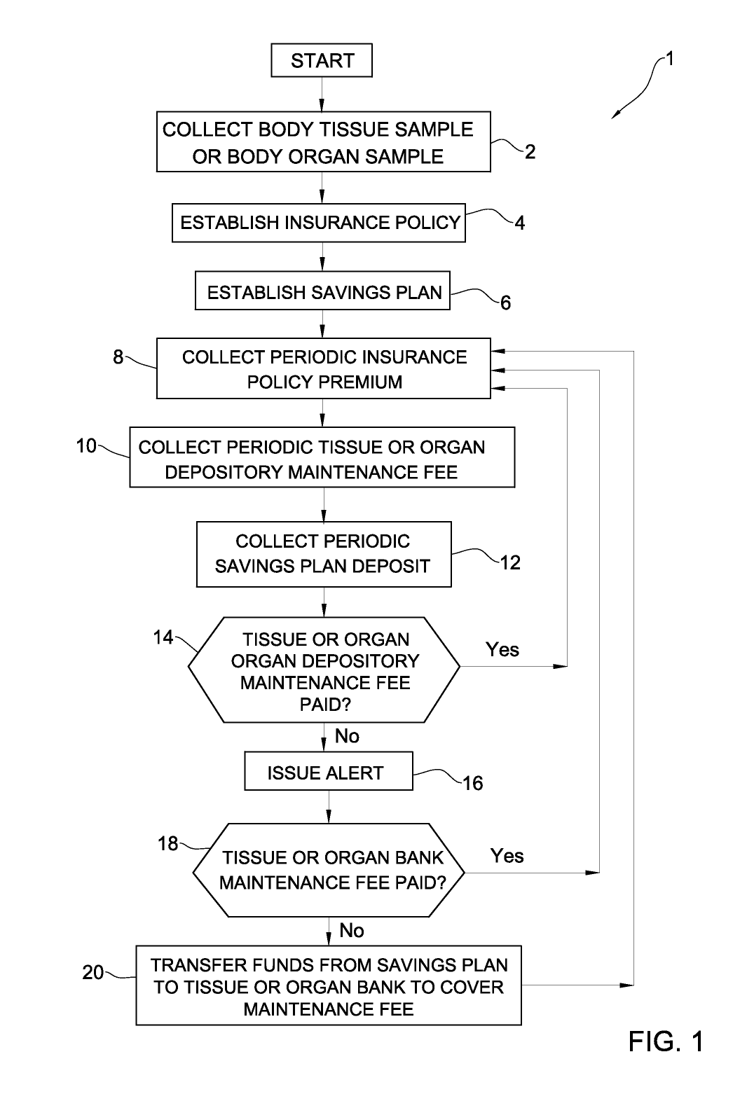

FIG. 1 shows a method 1 for providing insurance in accordance with one embodiment of this aspect of the invention. The method begins in step 2 with the collection of a body tissue sample or a body organ sample from an individual. An insurance policy is then established stipulating that the depositor or a beneficiary of a depositor is indemnified for expenses incurred for a medical or cosmetic treatment requiring body material of the type deposited by the depositor. The medical treatment may utilize either the deposited body material or substitute body material of the type deposited by the depositor (step 4). A savings plan is also established (step 6) specifying that an accrued value of the savings plan may be utilized to defer costs of maintaining the body tissue or body organ in the depository if the individual ceases to pay a predetermined periodic service payment to the depository. A periodic insurance premium is collected (step 8), and a periodic maintenance fee is collected (step 10). A periodic deposit is made to the savings plan (step 12). Periodically, it is determined whether any or all of the depository maintenance fees have been paid (step 14). If yes, then the method returns to step 8 with the periodic collection of the insurance policy premium and the depository maintenance fee. If at step 14 it is determined that one or more depository maintenance fees were not paid when due, then in step 16 an alert is issued. The alert may be an email message directed to any one or more of the depository, the individual who made the deposit or one of his beneficiaries, the institution managing the savings plan, or the insurance company. Sometime after issuing the alert, it is again determined whether any or all of the depository maintenance fees have been paid (step 18). If yes, then the process returns to step 8 with the periodic collection of the insurance policy premium and the depository maintenance fee. If in step 18 it was determined that one or more depository maintenance fees are still outstanding, then the process proceeds to step 20 where funds in the savings plan are used to defray all or some of the outstanding sum due to the depository for maintenance fees. The process can then return to step 8 with the periodic collection of the insurance premium and the depository maintenance fee.

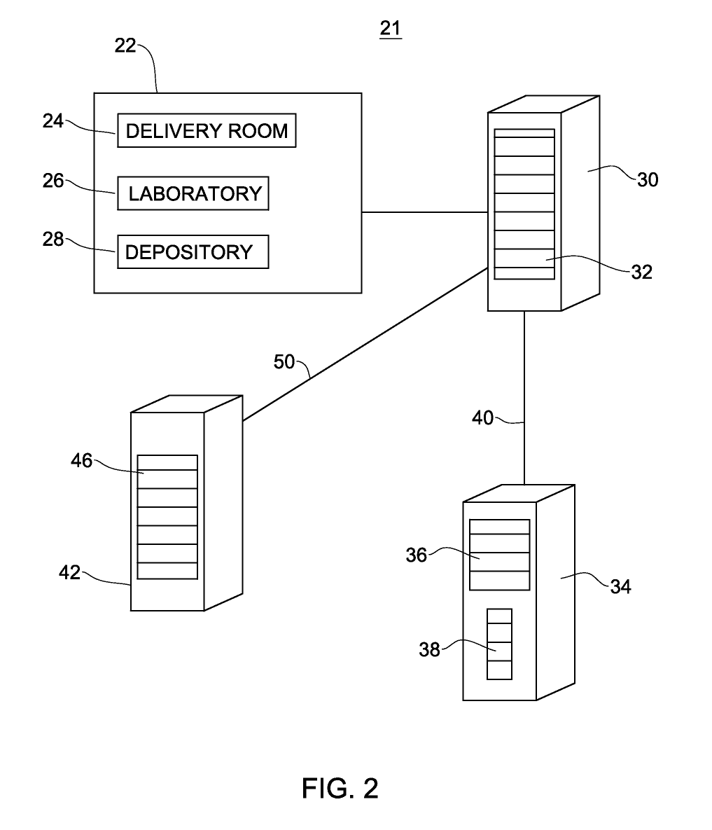

FIG. 2 shows a system 21 in accordance with one embodiment of this aspect of the invention. The system 21 includes a collection arrangement 22 where a tissue or organ sample is collected, processed and stored. The medical installation may be a distributed installation, in which collection of the blood occurs at one location (e.g. a delivery room 24), processing the sample at a second location (e.g. a laboratory 26), and storage of the sample is at a remotely located umbilical cord-blood depository 28. The system 21 further includes a first processor 30 having a memory comprising a databank of entries 32. Each entry 32 in the databank includes information relating to a deposit of material at the depository 28 when a deposit is made at the depository 28. The information is input to the entry from a computer terminal (not shown in FIG. 2) located at the depository that communicates with the processor 30 over a communication line 33 that may be a wired or wireless communication line. Details relating to the deposit include, for example, the depositor's name and other personal information, the date that the deposit was made, the volume of the deposit, any information relating to the deposit such as the results of any immunological tests that were performed on the sample. The stored information may also include a serial number or other identifier associated with the deposit, as well as the location of the deposited blood in the blood depository.

The system 21 also includes a second processor 34. The second processor 34 is maintained by an insurance provider and includes a memory comprising a first databank of entries 36 and a second databank of entries 38. The first and second processors communicate with each other over a communication line 40. When a new entry 32 is made in the databank of the first processor, the first processor is configured to communicate at least some of the data in the entry 32 to the second processor of the communication line 40. The second processor is configured to input the data and to store the input data into a new entry in the first database of the second processor. The second processor is further configured to alert the insurance company when a new entry has been made in the first database of the second processor, indicative of a new deposit at the cord-blood depository. This may be done, for example, by the second processor automatically sending an electronic message to a predetermined address informing the recipient of the message of the new deposit at the depository 28. The message prompts the insurance provider to query the depositor of the deposit as to whether the depositor wishes to acquire from the insurance company an insurance policy that indemnifies the depositor for at least some of the expenses incurred in a medical or cosmetic treatment utilizing the sample was deposited by the depositor in the depository. If the depositor elects to acquire an insurance policy from the insurance company, details relating to the acquired policy are stored in a new entry 38 in the second database of the second processor. Each entry of the second database of the second processor thus contains data relating to an insurance policy sold by the insurance company to a depositor at the depository, where the insurance policy indemnifies the depositor for expenses incurred for a medical or cosmetic treatment utilizing the deposited material.

The system 21 also includes a third processor 42. The third processor 42 is maintained by a savings institution, such as a bank, and includes a memory comprising a databank of entries 46. The first databank of entries comprises. The first and second processors communicate with each other over a communication line 50. When a new entry 32 is made in the databank of the first processor, the first processor is configured to communicate at least some of the data in the entry 32 to the third processor over the communication line 50. The third processor is configured to input the data and to store the input data into a new entry in the first database of the third processor.

When the third processor receives data indicative of a new deposit made at the depository, the third processor establishes a savings plan in which the depository makes periodic monetary deposits, for example, a sum may be deposited every month in the savings institution.

The first processor is further configured to determine when one or more maintenance fees that should have been paid to the depository 28 have not been paid by the depositor. When the first processor determines that one or more depository maintenance fees have not been paid, it instructs the third processor 42 to transfer a sum of money from the savings plan to an account of the depository 28. The sum that is transferred, may be less than, the same as, or more than, the amount due by the depositor to the depository.

1. A combination comprising:
(a) an insurance policy stipulating that a depositor or a beneficiary of a depositor is indemnified for expenses incurred for a medical or cosmetic treatment requiring body material of the type deposited by the depositor, wherein the medical treatment utilizes either the deposited body material or substitute body material of the type deposited by the depositor; and
(b) a savings plan in which a periodic deposit is made and specifying that an accrued value of the savings plan may be utilized to defer costs of maintaining the body tissue or body organ in the depository if the individual ceases to pay a predetermined periodic service payment to the depository.

2. A method for providing insurance comprising:
(a) establishing an insurance policy stipulating that a depositor or a beneficiary of a depositor is indemnified for expenses incurred for a medical or cosmetic treatment requiring body material of the type deposited by the depositor, wherein the medical treatment utilizes either the deposited body material or substitute body material of the type deposited by the depositor; and
(b) establishing a savings plan in which a periodic deposit is made and specifying that an accrued value of the savings plan may be utilized to defer costs of maintaining the body tissue or body organ in the depository if the individual ceases to pay a predetermined periodic service payment to the depository.

3. The method according to claim 1, further comprising indemnifying the depositor or beneficiary of the depositor for expenses incurred for a medical treatment utilizing the deposited body material.

4. The method according to claim 1, wherein the deposited body material is selected from blood, umbilical cord blood, skin, foreskin, lymph, adult stem cells, fetal stem cells sperm, and DNA.

5. The method according to claim 1, further comprising storing in a database data indicative of the insurance policy.

6. The method according to claim 1, further comprising storing in a database data indicative of the savings plan.

7. The method according to claim 4, wherein stored data is any one or more of a name of a holder of the insurance policy, the date that the deposit was made, information relating to the deposited body material, a serial number or other identifier associated with the deposit, a location of the deposited body material in the depository, a periodic sum to be deposited in the savings plan.

8. The method according to claim 6, wherein stored data is a periodic sum to be deposited in the savings plan.

9. A system for providing combination, the combination comprising:
(a) an insurance policy stipulating that a depositor or a beneficiary of a depositor is indemnified for expenses incurred for a medical or cosmetic treatment requiring body material of the type deposited by the depositor, wherein the medical treatment utilizes either the deposited body material or substitute body material of the type deposited by the depositor; and
(b) a savings plan in which a periodic deposit is made and specifying that an accrued value of the savings plan may be utilized to defer costs of maintaining the body tissue or body organ in the depository if the individual ceases to pay a predetermined periodic service payment to the depository;
the system comprising a processor and a database of entries, the processor configured to:
(a) input data indicative of an insurance policy provided by an insurance provider to a depositor of body material in a depository of body material, and to store the data in an entry of the database, the insurance policy stipulating that the depositor or a beneficiary of the depositor is indemnified for expenses incurred for a medical or cosmetic treatment utilizing the deposited body material or substitute body material of the type deposited by the depositor; and
(b) input data indicative of a savings plan in which a periodic deposit is made, the savings plan specifying that an accrued value of the savings plan may be utilized to defer costs of maintaining the body tissue or body organ in the depository if the individual ceases to pay a predetermined periodic service payment to the depository;
(c) input data indicative of service payments made by the individual;
(d) issue an alert when a service payment was not paid when the service payment was due.

10. The system according to claim 9 wherein the processor is configured to indemnify the depositor or beneficiary of the depositor for expenses incurred for a medical treatment utilizing the deposited body material.

11. The system according to claim 9 wherein the deposited body material is selected from blood, umbilical cord blood, skin, foreskin, lymph, adult stem cells, fetal stem cells sperm, and DNA.

12. The system according to claim 9, wherein the processor is configured to store in a database data indicative of the insurance policy.

13. The system according to claim 9, wherein the processor is configured to store in a database data indicative of the savings plan.

14. The system according to claim 12, wherein stored data is any one or more of a name of a holder of the insurance policy, the date that the deposit was made, information relating to the deposited body material, a serial number or other identifier associated with the deposit, a location of the deposited body material in the depository, a periodic sum to be deposited in the savings plan.

15. The system according to claim 14, wherein stored data is a periodic sum to be deposited in the savings plan.
